(19) United States
(12) Patent Application Publication
(10) Pub. No.: US 2005/0256836 A1
(43) Pub. Date: Nov. 17, 2005

(54) HTML file processing technique

(75) Inventors: Yasuhiko Awamoto, Shinagawa (JP); Hisao Sasaki, Shinagawa (JP); Yoshiyuki Okada, Shinagawa (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/948,293

(22) Filed: Sep. 24, 2004

(30) Foreign Application Priority Data
May 17, 2004 (JP) 2004-145934

(51) Int. Cl. G06F 7/00

(52) U.S. Cl. 707/1

(57) ABSTRACT

An HTML (Hyper Text Markup Language) file processing method of the invention comprises: specifying a character string not influencing a display at a user terminal in an HTML file received from another server according to a request from the user terminal by referring to a definition data storage storing data for specifying the character string not influencing the display at the user terminal; and changing the HTML file so as to reduce data amount in accordance with a method corresponding to an attribute of the specified character string, and transmitting the changed HTML file to the user terminal. As stated above, because the data amount of the HTML file is reduced by performing the processing with respect to the character string not influencing the display at the user terminal, the user at the user terminal is unconscious of the performance of the method according to this invention, and the smooth communication of the Web page data including the HTML file becomes possible. Besides, because the data amount is reduced, the communication charge can also be reduced.

### TECHNICAL FIELD OF THE INVENTION

The present invention relates to a relay processing technique between a Web site and a client terminal.

### BACKGROUND OF THE INVENTION

For example, JP-A-10-177528 discloses a technique in which for the purpose of reducing the information amount of outgoing information, unnecessary information specified by a user is deleted from hypertext information stored in a WWW server on the basis of transmission cancel information stored in a transmission cancel information storage, and the hypertext information after the deletion is transmitted to a terminal. However, according to the technique disclosed in this publication, although the information amount of the outgoing information can be reduced, display contents at the terminal are changed.

JP-A-2003-58445 discloses a technique in which an application for expanding compressed digital information is delivered to a cellular phone through the Internet network and a wireless communication network, contents information is received from a Web server, compressed digital information is generated, and the compressed digital information is delivered to the cellular phone through the Internet network and the wireless communication network. Besides, this publication discloses that an encryption processing is performed as the need arises. However, the application for expanding the compressed digital information must be transmitted to the cellular phone or the like, and there is a problem that display processing becomes slow because of the processing performance of the cellular phone. Besides, there is also a case where data communication amount becomes large due to the transmission of the application for expanding the compression digital information. The encryption processing also increases the processing load at the terminal side.

Although even by a PDA (Personal Digital Assistant) and a cellular phone, a user can access Web sites and browse Web pages, because the communication speeds of these equipments are often low, there are problems that it takes long time to download Web page data and in a case where the data amount of Web page data is large, the cost becomes high when billing is made in packet units. Besides, although an SSL (Secure Socket Layer) is often used to ensure the security, the PDA and the cellular phone have problems in the communication speed and display speed.

On the other hand, in the background art as described above, the communication amount is reduced in such a form as to influence the display contents, and it is necessary to add a special function to the terminal side.

### SUMMARY OF THE INVENTION

An object of the invention is therefore to provide a novel technique for reducing communication data amount in Web access without influencing a display at a terminal.

Another object of the invention is to provide a novel technique for raising a security level in Web access without adding a special function to a terminal.

An HTML (Hyper Text Markup Language) file processing method of the invention comprises: specifying a character string not influencing a display at a user terminal in an HTML file received from another server according to a request from the user terminal by referring to a definition data storage storing data for specifying the character string not influencing the display at the user terminal; and changing the HTML file so as to reduce data amount in accordance with a method corresponding to an attribute of the specified character string, and transmitting the changed HTML file to the user terminal.

As stated above, because the data amount of the HTML file is reduced by performing the processing with respect to the character string not influencing the display at the user terminal, the user at the user terminal is unconscious of the performance of the method according to this invention, and the smooth communication of the Web page data including the HTML file becomes possible. Besides, because the data amount is reduced, the communication charge can also be reduced.

In addition, the aforementioned changing and transmitting may comprise: if the specified character string is a character string having a possibility that it is sent back from the user terminal, assigning a code to the specified character string, and constructing a correspondence table between the character string and the code; and changing the HTML file in accordance with the correspondence table, and transmitting the changed HTML file to the user terminal.

As stated above, in the case where the character string does not influence the display and has a possibility that it is sent back, the character string is changed into the code so that the communication data amount can be reduced. Further, when another person cannot acquire the correspondence table, even if another person looks furtively at the HTML file, a next processing can not be performed, and therefore, the security level can also be raised.

Further, the aforementioned changing and transmitting may comprise: if the specified character string is a duplicate tag for specifying a display mode of a character, generating an HTML file not containing the specified character string. When Web page data is created using a commercial homepage creation program, a tag for specifying a display mode of a character is often duplicatively defined even in the case where the display mode is not changed. Originally, because in the case of the same display mode, the duplicate definition is unnecessary, even if it is deleted, there is no problem on the display. That is, the communication data amount can be reduced without influencing the display at the user terminal.

Further, the aforementioned definition data storage may store a tag name not influencing the display at the user terminal and an attribute name in the tag. In this case, the aforementioned specifying may comprise: judging whether in the HTML file, an attribute having the attribute name stored in the definition data storage is prescribed in a tag having the tag name stored in the definition data storage; and if it is judged at the judging that the attribute having the attribute name stored in the definition data storage is prescribed in the tag having the tag name stored in the definition data storage, specifying the attribute value as the character string. Incidentally, according to circumstances, there is also a case where a condition is further defined according to a specific attribute and its attribute value.

Incidentally, a program for causing a processor to execute the method according to this invention can be created, and the program is stored in a storage medium or storage device, such as a flexible disk, CD-ROM, magneto-optic disk, semiconductor memory, and hard disk. Furthermore, it may be distributed as digital signals via a network. Incidentally, intermediate processing data is temporality stored in a storage device, such as a memory.

### BRIEF DESCRIPTION OF THE DRAWINGS

FIG. 1 is a system outline diagram in a first embodiment of the invention;

FIG. 2 is a functional block diagram of a duplicate definition delete processor;

FIG. 3 is a functional block diagram of a code conversion processor;

FIG. 4 is a diagram showing a main processing flow in the first embodiment of the invention;

FIG. 5 is a diagram showing an example of a display mode setting screen of characters;

FIG. 6 is a diagram showing an example of an HTML file created in a generally sold homepage creation program;

FIG. 7 is a diagram showing a display example of the HTML file shown in FIG. 6;

FIG. 8 is a diagram showing a processing flow of a duplicate definition delete processing;

FIG. 9 is a diagram showing an example of a check definition table;

FIG. 10A is a diagram showing a comparison table in a first state, FIG. 10B is a diagram showing the comparison table in a second state, FIG. 10C is a diagram showing the comparison table in a third state, FIG. 10D is a diagram showing the comparison table in a fourth state, FIG. 10E is a diagram showing the comparison table in a fifth state, FIG. 10F is a diagram showing data stored in an end tag storage in a sixth state, FIG. 10G is a diagram showing data stored in the end tag storage in a seventh state, FIG. 10H is a diagram showing the comparison table in an eighth state, and FIG. 10I is a diagram showing data stored in the end tag storage in a ninth state;

FIG. 11 is a diagram showing an example of an HTML file after a duplicate definition deletion processing;

FIG. 12 is a diagram showing a processing flow of a code conversion processing;

FIG. 13 is a diagram showing an example of an extraction definition data table;

FIG. 14 is a diagram showing an example of an HTML file to explain the code conversion processing;

FIG. 15 is a diagram showing an example of a conversion table;

FIG. 16 is a diagram showing an example of an HTML file after the code conversion;

FIG. 17 is a diagram showing a display example of the HTML files in FIGS. 14 and 16;

FIG. 18 is a system outline diagram in a second embodiment of the invention;

FIG. 19A is a diagram showing an example of immediately preceding display contents, and FIG. 19B is a diagram showing an example of a next Web page;

FIG. 20 is a diagram showing a processing flow in the second embodiment of the invention;

FIG. 21A is a schematic diagram of character strings of the immediately preceding HTML file, FIG. 21B is a schematic diagram of character strings of the current HTML file, and FIG. 21C is a schematic diagram of difference data; and

FIG. 22 is a functional block diagram of a computer system.

### DETAILED DESCRIPTION OF THE INVENTION

### 1. First Embodiment

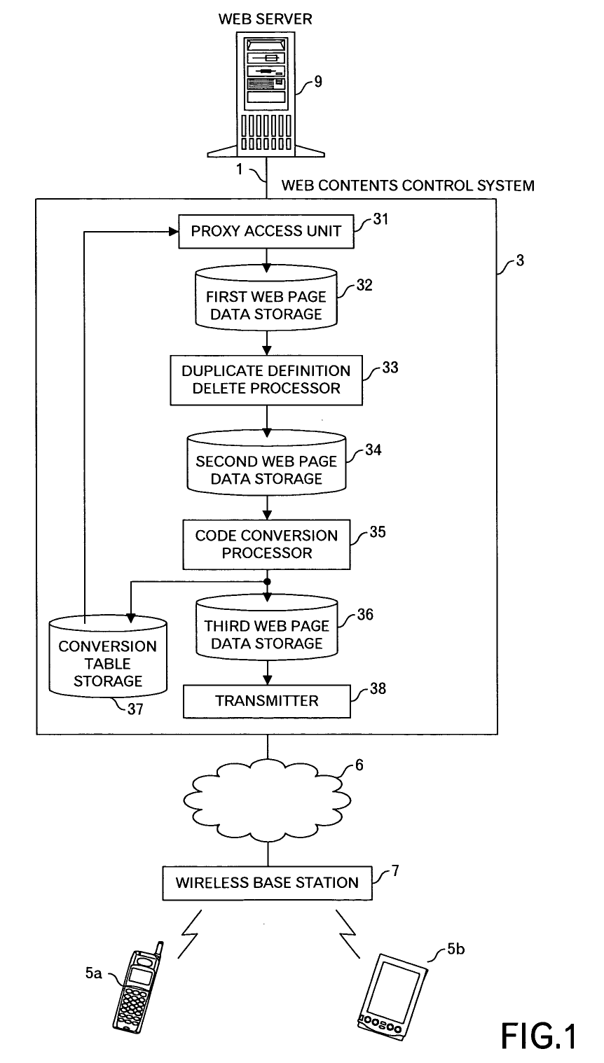

FIG. 1 is a system outline diagram of a first embodiment of the invention. A network 1 as, for example, the Internet or a LAN (Local Area Network) is connected with one or plural Web servers 9, and a Web contents control system 3 for performing a main processing of this embodiment. The Web contents control system 3 is connected with a wireless base station 7 through a network 6 such as the Internet. A cellular phone 5a and a PDA 5b, which have a Web browser, are connected with the wireless base station 7 by wireless. Although the number of cellular phones, PDAs, or wireless base stations is not particularly limited, because they are not main portions of this embodiment, they are shown here one by one. Besides, the network 1 and the network 6 may be any form of network.

The Web contents control system 3 is provided between the Web server 9 and the cellular phone 5a and/or the PDA 5b, is a system for relaying Web page data, and is composed of one or plural servers. The Web contents control system 3 includes a proxy access unit 31 which accesses the Web server 9 or the like on behalf of the cellular phone 5a or the like and stores acquired Web page data into a first Web page data storage 32, the first Web page data storage 32 for storing the Web page data acquired by the proxy access unit 31, a duplicate definition delete processor 33 which refers to the Web page data storage 32, performs a duplicate definition delete processing described below in detail, and stores processing results into a second Web page data storage 34, the second Web page data storage 34 for storing the processing results of the duplicate definition delete processor 33, a code conversion processor 35 which refers to the second Web page data storage 34, performs a code conversion processing described below in detail, and stores processing results into a third Web page data storage 36 and a conversion table storage 37, the third Web page data storage 36 for storing the processing results of the code conversion processor 35, the conversion table storage 37 for storing a conversion table as the processing results of the code conversion processor 35, and a transmitter 38 which refers to the third Web page data storage 36 and transmits the Web page data to the cellular phone 5a or the like as a requester. The proxy access unit 31 also refers to the conversion table storage 37. It is assumed that the correspondence between a received URL (Uniform Resource Locator) and a URL of a transfer destination Web server is previously registered in the Web contents control system 3.

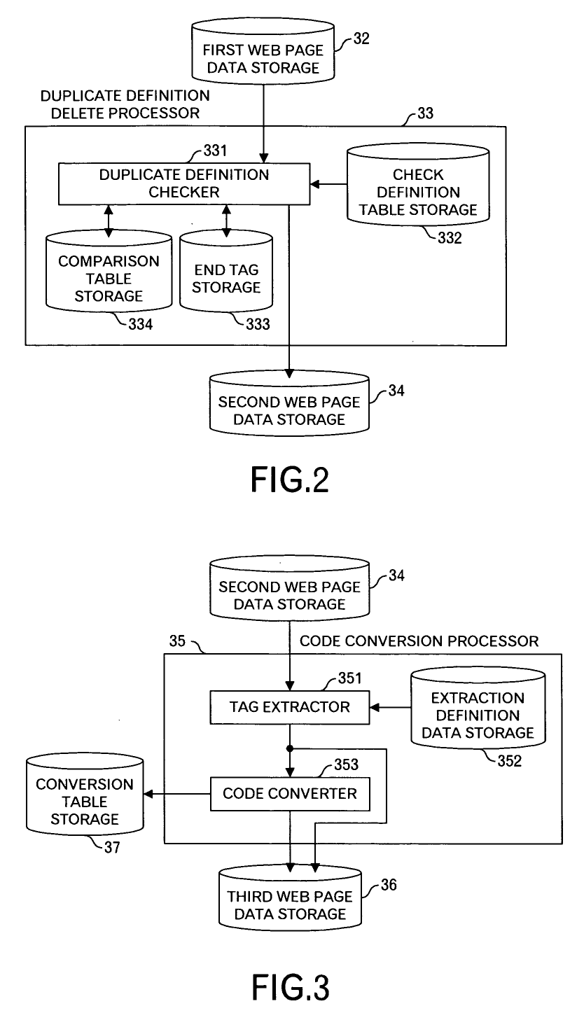

Next, FIG. 2 is a detailed functional block diagram of the duplicate definition delete processor 33. The duplicate definition delete processor 33 includes a duplicate definition checker 331, a check definition table storage 332, a comparison table storage 334, and an end tag storage 333. The duplicate definition checker 331 checks an HTML file stored in the first Web page data storage 32 in accordance with a check definition table stored in the check definition table storage 332, and uses data stored in the comparison table storage 334 and the end tag storage 333 to perform a processing of deleting a duplicate tag. The processing result of the duplicate definition checker 331 is stored in the second Web page data storage 34. The data stored in the check definition table storage 332, the comparison table storage 334 and the end tag storage 333 will be described in a following processing flow.

FIG. 3 is a detailed functional block diagram of the code conversion processor 35. The code conversion processor 35 includes a tag extractor 351, an extraction definition data storage 352, and a code converter 353. The tag extractor 351 processes an HTML file stored in the second Web page data storage 34 in accordance with extraction definition data stored in the extraction definition data storage 352, outputs tag data coincident with the extraction definition data to the code converter 353, and outputs data inconsistent with the extraction definition data to the third Web page data storage 36. The code converter 353 performs code conversion of an attribute value in the tag data received from the tag extractor 351 in accordance with a predetermined rule, registers the correspondence between the attribute value and the code into a conversion table of the conversion table storage 37, and outputs the tag data whose attribute value is replaced with the code to the third Web page data storage 36. Incidentally, the conversion table of the conversion table storage 37 is used also by the proxy access unit 31 in order to convert a code received from the cellular phone 5a or the like to an original attribute value. The data stored in the extraction definition data storage 352 and the conversion table storage 37 will be described in the following processing flow.

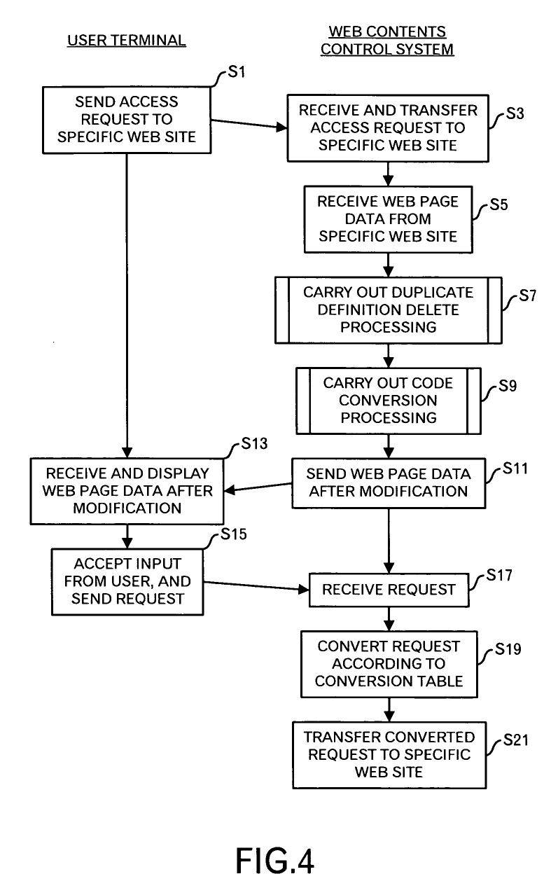

Next, the processing flow of the system shown in FIGS. 1 to 3 will be described with reference to FIGS. 4 to 17. First, in accordance with an instruction of the user, the user terminal (the cellular phone 5a and/or the PDA 5b, and the same shall apply hereinafter) transmits a request for accessing a specific Web site to the Web contents control system 3 (step S1). Incidentally, when the service of the Web contents control system 3 requires authentication, it is assumed that an authentication processing has already been performed. When receiving the access request for the specific Web site (for example, the Web server 9) from the user terminal, the proxy access unit 31 of the Web contents control system 3 transfers the access request to the specific Web site (step S3). The proxy access unit 31 confirms whether data to specify a session, such as a cookie, is contained in the access request. Here, for the purpose of making the explanation understandable, the description will be made on the assumption that the data to specify the session is not contained. The proxy access unit receives Web page data (here, HTML file) corresponding to the access request from the specific Web site, and stores it in the first Web page data storage 32 (step S5). With respect to a file other than the HTML file, because it is not a processing object of this embodiment, subsequent processing is skipped.

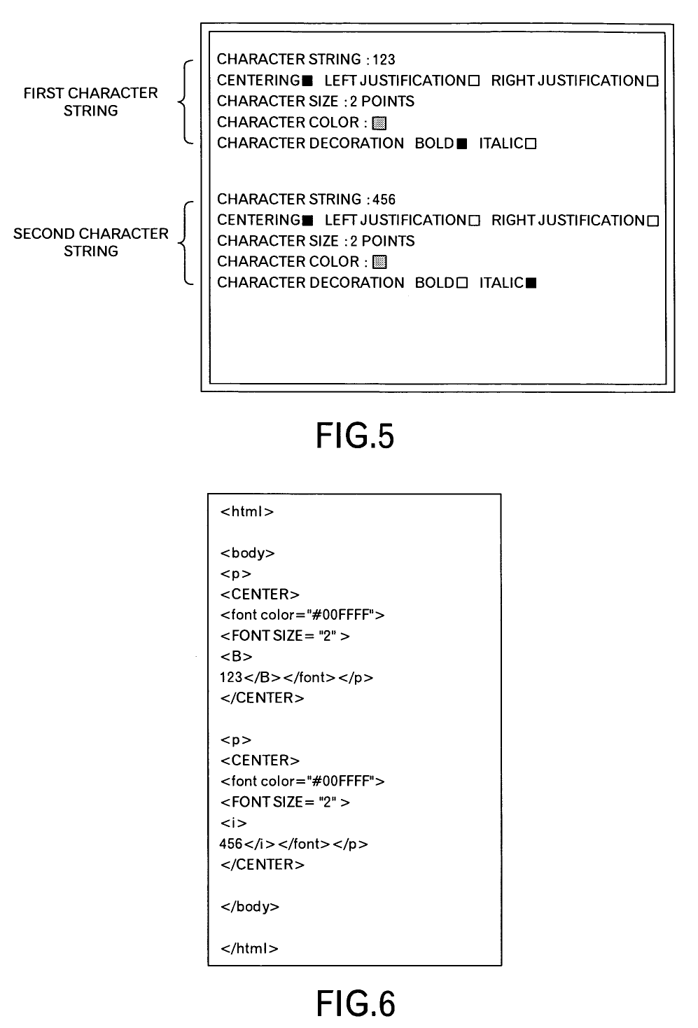

Next, the duplicate definition delete processor 33 performs the duplicate definition delete processing to the HTML file stored in the first Web page data storage 32 (step S7). This processing will be described with reference to FIGS. 5 to 11.

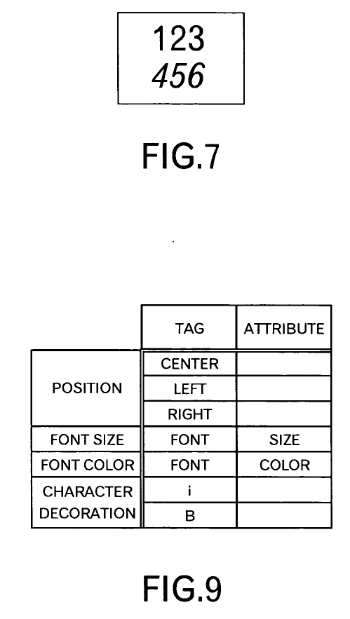

First, the outline of this processing will be described with reference to FIGS. 5 to 7. When a homepage creation program generally on sale is used, with respect to character strings to be displayed on the screen, tags for defining a display mode are prescribed for each of the character strings. That is, as shown in FIG. 5, with respect to a first character string “123”, a character position such as centering, left justification or right justification is set, a character size is set, a character color is set, and a character decoration such as bold or italic is set. Further, with respect to a second character string “456”, similarly, a character position is set, a character size is set, a character color is set, and a character decoration is set. In the example of FIG. 5, with respect to the first character string, “centering”, “2 points”, “character color (blue)”, and “bold are set. With respect to the second character string, “centering”, “2 points”, “character color (blue)”, and “italic” are set. Accordingly, when an HTML file is constructed in accordance with such settings, a file as shown in FIG. 6 is created. FIG. 6 includes an <HTML> tag, a <BODY> tag, a <P> tag, a <CENTER> tag, a <FONT> tag in which a color attribute is prescribed, a <FONT> tag in which a size attribute is prescribed, a <B> tag, a character string “123”, a </B> tag, a </FONT> tag, a </P> tag, a </CENTER> tag, a <P> tag, a <CENTER> tag, a <FONT> tag in which a color attribute is prescribed, a <FONT> tag in which a size attribute is prescribed, an <i> tag, a character string “456”, a </i> tag, a </FONT> tag, a </P> tag, a </CENTER> tag, a </BODY> tag, and an </HTML> tag. As a result, a screen display as shown in FIG. 7 is realized. However, according to the HTML, with respect to settings common to the first character string and the second character string, it is not necessary to separately provide the tags. In the example of FIG. 5, a different portion is only the character decoration, and the other character position, character size, and character color are common to each other. Thus, the <CENTER> tag and the </CENTER> tag, the <FONT> tag in which the color attribute is prescribed, the <FONT> tag in which the size attribute is prescribed, and the </FONT> tag are redundant. Accordingly, in this processing, the redundant tags as stated above are deleted, so that the communication data amount is reduced.

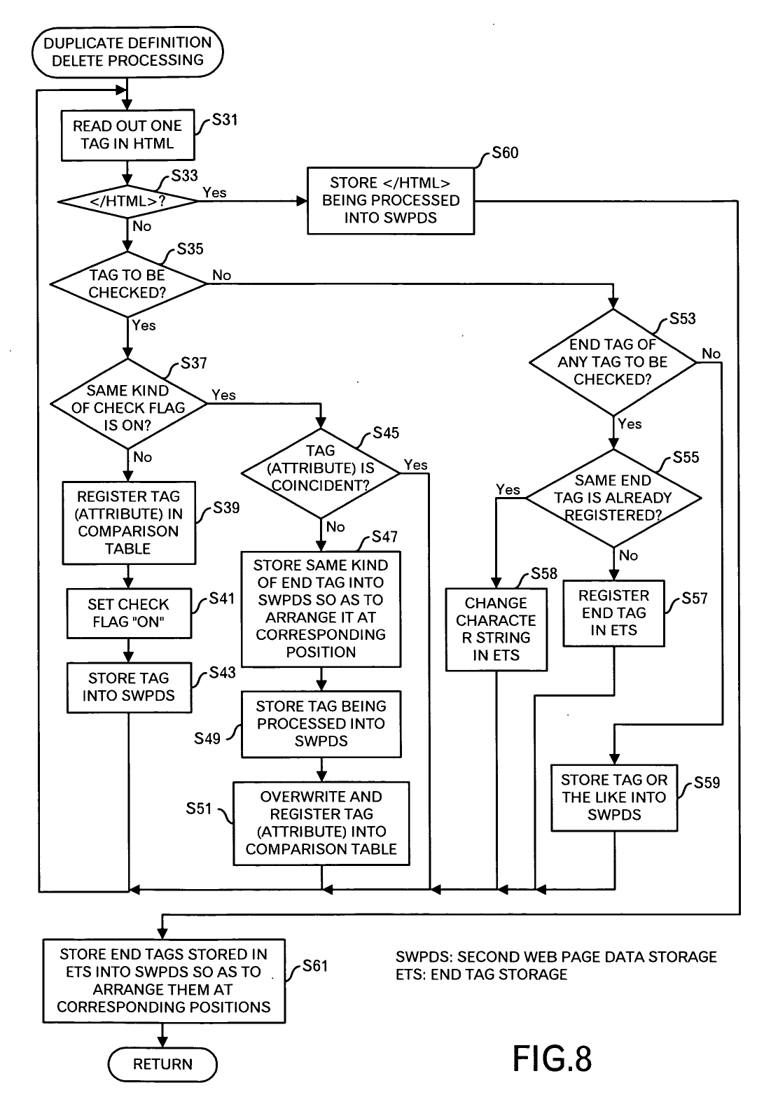

Next, a specific processing flow will be described with reference to FIGS. 8 to 11. The duplicate definition checker 331 of the duplicate definition delete processor 33 reads out one tag (with respect to a character string which is not a tag, all character strings until a next tag is detected) from the HTML file stored in the first Web page data storage 32 into a storage device such as, for example, a main memory (FIG. 8: step S31). It judges whether the read tag is the </HTML> tag (step S33). That is, it judges whether the end tag of the HTML file is read out. In the case where it is judged that the tag is the </HTML> tag, the processing proceeds to step S60. When it is judged that the tag is not the </HTML> tag, by referring to the check definition table stored in the check definition table storage 332, it judges whether the tag to be checked has been read out (step S35). The check definition table is, for example, the data table as shown in FIG. 9. That is, as data of tags to be checked, there are prescribed a tag concerning a position (<CENTER> tag, <LEFT> tag, <RIGHT> tag), a tag concerning a font size (<FONT> tag) and an attribute (size), a tag concerning a font color (<FONT> tag) and an attribute (color), and a tag concerning a character decoration (<i> tag, <B> tag).

In the case where it is judged at the step S35 that the tag is not a tag to be checked, it judges whether the tag is an end tag of any tag to be checked (step S53). For example, in the example of FIG. 6, in the case where the tags from the <HTML> tag to the <P> tag are processed, the processing proceeds to step S53 through the step S33 and the step S35, and it judges at the step S53 whether the tag is an end tag of any tag to be checked. In the case where it is judged at the step S53 that the tag is not the end tag of any tag to be checked, it stores the tag in the second Web page data storage 34 (step S59). The processing proceeds to the step S31.

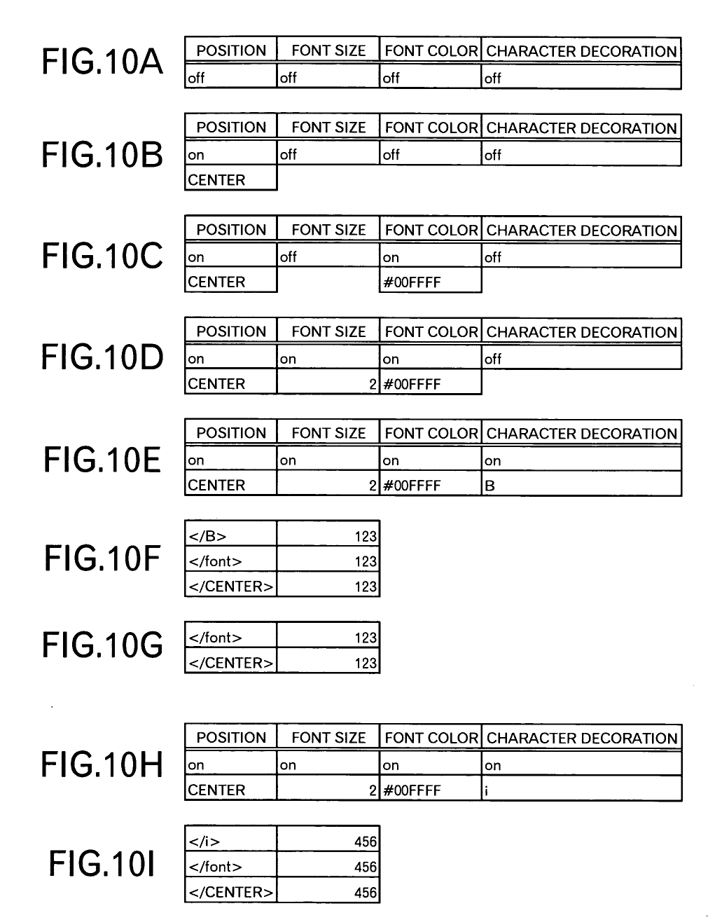

On the other hand, in the case where it is judged at the step S35 that the tag is the tag to be checked, it judges whether the same kind of check flag is set to ON (step S37). The duplicate definition checker 331 refers to the comparison table of the comparison table storage 334, and judges whether the same kind of check flag is ON. The initial state of the comparison table is shown in FIG. 10A. As shown in FIG. 10A, the comparison table is provided with a check flag of a tag concerning the position, a check flag of a tag concerning the font size, a check flag of a tag concerning the font color, and a check flag of a tag concerning the character decoration. Initially, as shown in FIG. 10A, all flags are OFF. For example, in the case where the <CENTER> tag in FIG. 6 is processed, it refers to the check flag of the tag concerning the position, and because all the check flags are OFF, the processing proceeds to step S39 here.

That is, in the case where the same kind of check flag is OFF, the tag (or attribute value) is stored in the comparison table of the comparison table storage 334 (step S39). In the comparison table, it sets the check flag corresponding to the kind of the tag being processed to ON (step S41). In the case of the <CENTER> tag in FIG. 6, as shown in FIG. 10B, it sets the check flag of the tag concerning the position to ON, and registers the tag name (CENTER). Further, it stores the tag being processed into the second Web page data storage 34 (step S43). Thereafter, the processing returns to the step S31.

In the case where the tag <font color=“#00FFFF”> concerning the font color in FIG. 6 is processed, the processing is performed through the step S33, step S35, step S37, step S39, step S41 and step S43, and for example, the comparison table as shown in FIG. 10C is stored in the comparison table storage 334. That is, the check flag of the tag concerning the font color is set to ON, and the attribute value “#00FFFF” is registered.

In the case where the tag <FONT size=“2”> concerning the font size in FIG. 6 is processed, the processing is similarly performed through the step S33, step S35, step S37, step S39, step S41 and step S43, and for example, the comparison table as shown in FIG. 10D is stored in the comparison table storage 334. That is, the check flag concerning the font size is set to ON, and the attribute value “2” is registered.

In the case where the tag <B> concerning the character decoration in FIG. 6 is processed, the processing is similarly performed through the step S33, step S35, step S37, step S39, step S41, and step S43, and for example, the comparison table as shown in FIG. 10E is stored in the comparison table storage 334. That is, the check flag of the tag concerning the character decoration is set to ON, and the tag name (B) is registered.

Further, in the case where the character string “123” in FIG. 6 is processed, the processing is performed through the step S33, step S35, step S53, and step S59, and the character string “123” is stored in the second Web page data storage 34.

Next, in the case where the end tag </B> of the <B> tag concerning the character decoration in FIG. 6 is processed, through the step S33 and step S35 and at step S53, it refers to the check definition table storage 332, and it judges that the tag is the end tag of the tag to be checked. In this case, it judges whether the same end tag is already stored in the end tag storage 333 (step S55) In this case, any end tag is not yet registered in the end tag storage 333, the processing proceeds to step S57, and it registers the end tag in the end tag storage 333. When this end tag is arranged just before a next start tag of the same kind, there is no problem. However, here, a character string (effective character string) sandwiched between the end tag and the start tag corresponding thereto is stored in the end tag storage 333, so that it becomes possible to rearrange the end tag to a suitable position. Accordingly, in this embodiment, the final effective character string is registered in the end tag storage 333. With respect to the end tag </B> of the foregoing example, the character string “123” is registered with the end tag </B>.

In the case where the end tag </font> of the <font> tag concerning the font in FIG. 6 is processed, the end tag </font> and the character string “123” are stored in the end tag storage 333 through the step S33, step S35, step S53, step S55 and step S57.

Further, the </p> tag in FIG. 6 is processed through the step S33, step S35, step S53 and step S59, and is stored in the second Web page data storage 34.

In the case where the end tag </CENTER> of the <CENTER> tag concerning the position in FIG. 6 is processed, </CENTER> and the character string “123” are stored in the end tag storage 333 through the step S33, step S35, step S53, step S55 and step S57.

When the processing is performed up to now, the data as shown in FIG. 10F is stored in the end tag storage 333. That is, the end tag </B> and the character string “123”, the end tag </font> and the character string “123”, and the end tag </CENTER> and the character string “123” are stored.

Next, the <P> tag in FIG. 6 is processed through the step S33, step S35, step S53 and step S59, and is stored in the second Web page data storage 34.

In the case where the second <CENTER> tag in FIG. 6 is processed, through the step S33 and step S35 and at step S37, it judges that the same kind of check flag is ON. Accordingly, it judges whether the tag (or attribute value) is the same as one registered in the comparison table of the comparison table storage 334 (step S45). In this case, because “CENTER” is registered correspondingly to the check flag for the tag concerning the position, it is judged to be “coincident”. Then, nothing is made and the processing returns to the step S31. That is, the <CENTER> tag is deleted as a duplicate tag.

Next, in the case where the second <font color=“#00FFFF”> tag in FIG. 6 is processed, nothing is made and through the step S33, step S35, step S37 and step S45, the processing returns to the step S31. That is, the <font color=“#00FFFF”> tag is deleted as a duplicate tag.

Further, the second <font size=“2”> tag in FIG. 6 is processed, nothing is made and through the step S33, step S35, step S37 and step S45, the processing returns to the step S31. That is, the <font size=“2”> tag is deleted as a duplicate tag.

In the case where the <i> tag in FIG. 6 is processed, through the step S33, step S35 and step S37 and at the step S45, it judges that the tag (or attribute value) is not coincident. Accordingly, it stores the end tag of the same kind (here, the kind of the character decoration) stored in the end tag storage 333 into the second Web page data storage 34 so that it is arranged at a corresponding position (step S47). The data as shown in FIG. 10F is stored in the end tag storage 333, and the corresponding end tag </B> of the tag concerning the character decoration is stored into the second Web page data storage 34 so that it is arranged behind the character string “123”. Incidentally, the tag stored in the second Web page data storage 34 is deleted from the end tag storage 333. That is, the data as shown in FIG. 10G is stored in the end tag storage 333. Besides, it stores the tag being processed into the second Web page data storage 3-4 (step S49). Further, it overwrites and registers the tag (or attribute value) in the comparison table of the comparison table storage 334 (step S51). In this example, because “B” is registered as the tag concerning the character decoration, instead thereof, “i” is overwritten and registered. When the processing as stated above is performed, the data as shown in FIG. 10H is stored in the comparison table. That is, the check flag of the tag concerning the character decoration remains ON, and the tag name “i” is registered correspondingly. The remaining portion is the same as FIG. 10E. Thereafter, the processing returns to the step S31.

Further, in the case where the character string “456” in FIG. 6 is processed, the processing is performed through the step S33, step S35, step S53 and step S59, and the character string “456” is stored in the second Web page data storage 34.

In the case where the </i> tag in FIG. 6 is processed, the processing is performed through the step S33, step S35, step S53, step S55 and step S57, and the </i> tag and the character string “456” are stored in the end tag storage 333.

Next, the </font> in FIG. 6 is processed, through the step S33, step S35 and step S53 and at the step S55, it is judged that the same end tag has been registered in the end tag storage 333. Then, the character string registered correspondingly to the same end tag in the end tag storage 333 is changed to the current effective character string (step S58). That is, the character string “123” is changed to the character string “456”.

In the case where </P> in FIG. 6 is processed, it is processed through the step S33, step S35, step S53 and step S59, and is stored in the second Web page data storage 34.

Further, in the case where </CENTER> in FIG. 6 is processed, the processing is made through step S33, step S35, step S53, step S55 and step S58, and instead of the character string “123” registered correspondingly to the </CENTER> tag, the current effective character string “456” is registered. By the processing up to now, the data as shown in FIG. 10I is stored in the end tag storage 333.

In the case where </body> in FIG. 6 is processed, it is processed through the step S33, step S35, step S53 and step S59, and is stored in the second Web page data storage 34.

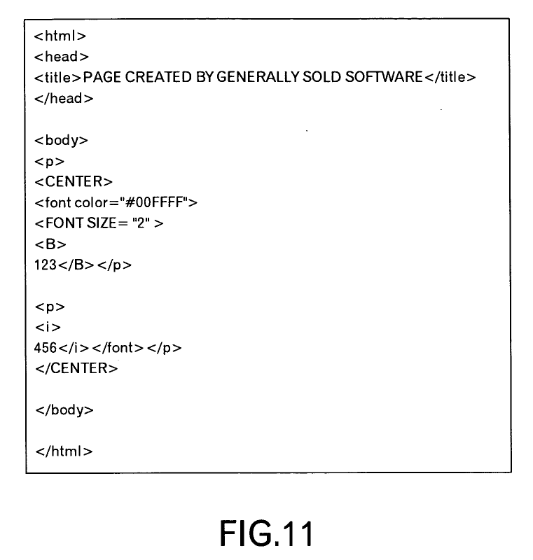

Finally, in the case where </HTML> in FIG. 6 is processed, through the step S33 and at step S60, the </HTML> tag is stored in the second Web page data storage 34. Besides, the end tag stored in the end tag storage 333 is stored in the second Web page data storage 34 so that it is arranged at a corresponding position. (step S61). Then, a return is made to the original processing. Because the data as shown in FIG. 10I is stored in the end tag storage 333, </font>, </CENTER> and </i> are arranged behind the character string “456”. Accordingly, the HTML file as shown in FIG. 11 is stored in the second Web page data storage 34.

The duplicate tag is deleted by performing the processing as stated above and the communication data amount is reduced.

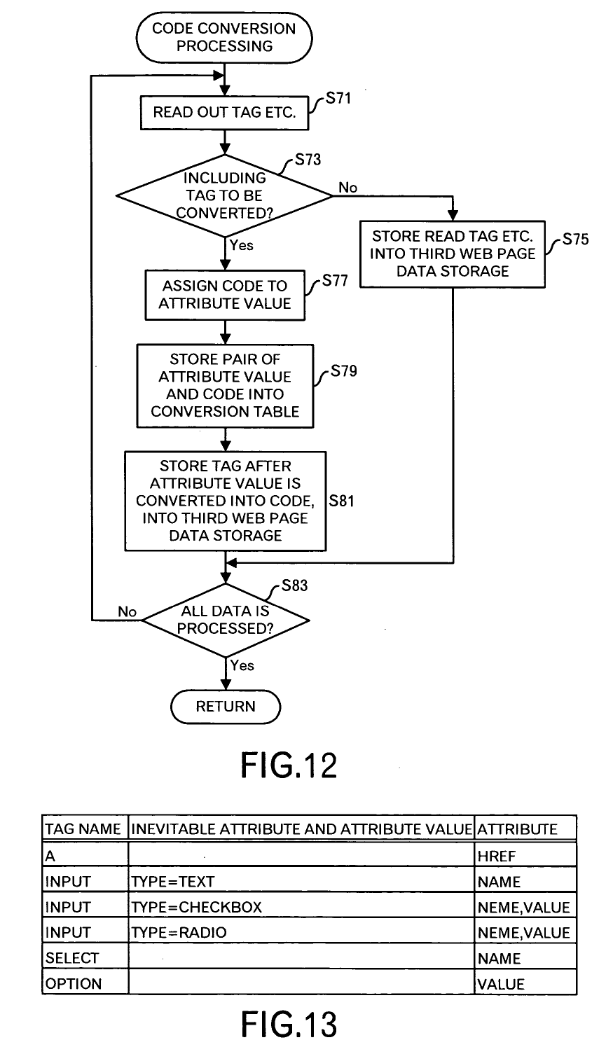

The processing returns to the processing of FIG. 4, and the code conversion processor 35 performs a code conversion processing (step S9). The code conversion processing will be described with reference to FIGS. 12 to 17. First, the tag extractor 351 of the code conversion processor 35 reads out a tag (in the case of something other than the tag, all character strings until a next tag) from the second Web page data storage 34 (FIG. 12: step S71). Then, by referring to the extraction definition data storage 352, it judged whether the tag is the tag containing a character string to be converted (step S73). An example of the extraction definition data storage 352 is shown in FIG. 13. FIG. 13 shows a table prescribing, as extraction definition data, the tag names of tags to be extracted and the attribute names of the tags. In this embodiment, the tag names include an <A> tag, an <INPUT> tag, a <SELECT> tag, and an <OPTION> tag. As for the <INPUT> tag, as attribute values of the TYPE attribute, “TEXT”, “CHECKBOX”, “RADIO” are prescribed as the inevitable attribute and attribute value at the extraction. That is, even if a tag is an <INPUT> tag, in the case where an attribute value of the TYPE attribute is “SUBMIT” or the like, because the inevitable attribute and attribute value are not coincident, the tag is not extracted. Besides, the attribute names to prescribe character strings to be extracted (attribute values) include a HREF attribute for the <A> tag, a NAME attribute for the <INPUT> tag and the inevitable attribute and attribute value TYPE=TEXT, a NAME attribute and a VALUE attribute for the <INPUT> tag and the inevitable attribute and attribute value TYPE=CHECKBOX, a NAME attribute and a VALUE attribute for the <INPUT> tag and the inevitable attribute and attribute value TYPE=RADIO, a NAME attribute for the <SELECT> tag, and a VALUE attribute for the <OPTION> tag. At the step S73, it first judges whether the tag name of the tag read out at the step S71 is registered in the table of FIG. 13, and whether the attribute and attribute value in the tag include the inevitable attribute and attribute value registered in the table of FIG. 13. In the case where this condition is satisfied, it judges whether an attribute other than the inevitable attribute in the tag is an attribute stored in the table of FIG. 13 correspondingly to the tag and the inevitable attribute and attribute value.

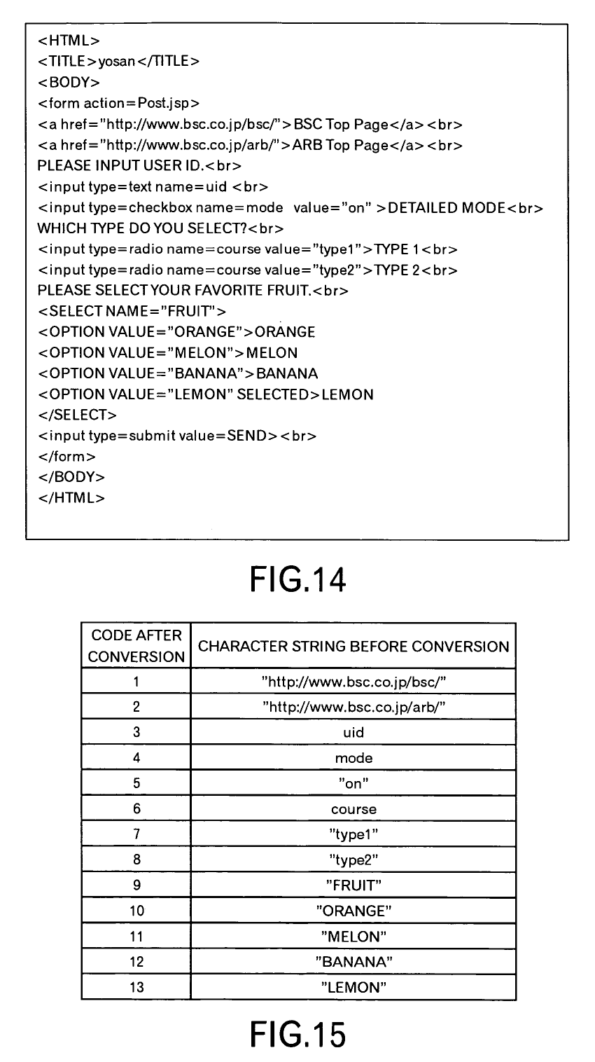

For example, it is assumed that the HTML file as shown in FIG. 14 is processed. With respect to tags from the first <HTML> tag to the <form action=Post.jsp> tag, it is judged at the step S73 that the tags are not tags including character strings to be converted, and the processing proceeds to the step S75. The read tags and the like are stored in the third Web page data storage 36. That is, the conversion processing is not particularly performed.

On the other hand, with respect to a <a href=“http://www.bsc.co.jp/bsc/”> tag in FIG. 14, it is judged at the step S73 that the tag is a tag including a character string to be converted. The code converter 353 assigns a code to the attribute value of the attribute specified at the step S73 (step S77). It registers the pair of the attribute value and the code in the conversion table of the conversion table storage 37 (step S79). When the length of the code is shorter than that of the character string of the conversion origin, the communication data amount can be reduced. When there is no relevance between the character string (attribute value) of the conversion origin and the code, for example, even if a person looks furtively at the HTML file containing the code after the conversion, the original character string can not be extracted from the code, and data, which will be sent after the HTML file, cannot be illegally acquired. Accordingly, a specific sequence, a random sequence, or character or symbol sequence is assigned. However, when the code is assigned in accordance with a sequence such as “1” “2” “3” although the specified character string is a character string such as “1” “2” “3”, this can be a meaningless case. Thus, it is preferable that the codes do not duplicate with the original character strings. In order to avoid such duplication, after all attribute values to be converted are extracted, a code not duplicating with the attribute values to be converted is assigned, and is registered in the conversion table. In this embodiment, for simplification of the description, in order of detection, a numeral is assigned as a code to a character string in accordance with a sequence such as “1” “2” “3”. Because there is also a case where the same attribute value appears in an HTML file many times, it is confirmed by referring to the conversion table that different codes are not assigned to the same attribute value.

The code converter 353 stores the tag, whose attribute value has been converted into the code, into the third Web page data storage 36 (step S81). The tag <a herf=“http://www.bsc.co.jp/bsc/”> is converted into <a herf=“1”> and is stored in the third Web page data storage 36.

The tag extractor 351 judges whether data of all tags and the like are processed (step S83). When the processing is performed until the final </HTML> tag, the processing of all tags is completed, and therefore, the processing returns to the original processing. On the other hand, when there is a tag or the like, which is not processed yet, the processing returns to the step S71.

In the example of FIG. 14, with respect to an <a href=“http://www.bsc.co.jp/arb/”> tag, an <input type=text name=uid> tag, an <input type=checkbox name=mode value=“on”> tag, an <input type=radio name=course value=“type 1”> tag, an <input type=radio name=course value=“type 2”> tag, a <select name=“FRUIT”> tag, an <OPTION VALUE=“ORANGE”> tag, an <OPTION VALUE=“MELON”> tag, an <OPTION VALUE=“BANANA”> tag, and an <OPTION VALUE=“LEMON” SELECTED> tag, their attribute values are converted into codes. Besides, like the <input type=checkbox name=mode value=“on”> tag, there is also a case where plural attribute values to be converted are contained in one tag.

On the other hand, in the example of FIG. 14, with respect to an <input type=submit value=send> tag, because the inevitable attribute and attribute value are not coincident, it is not extracted as a conversion object.

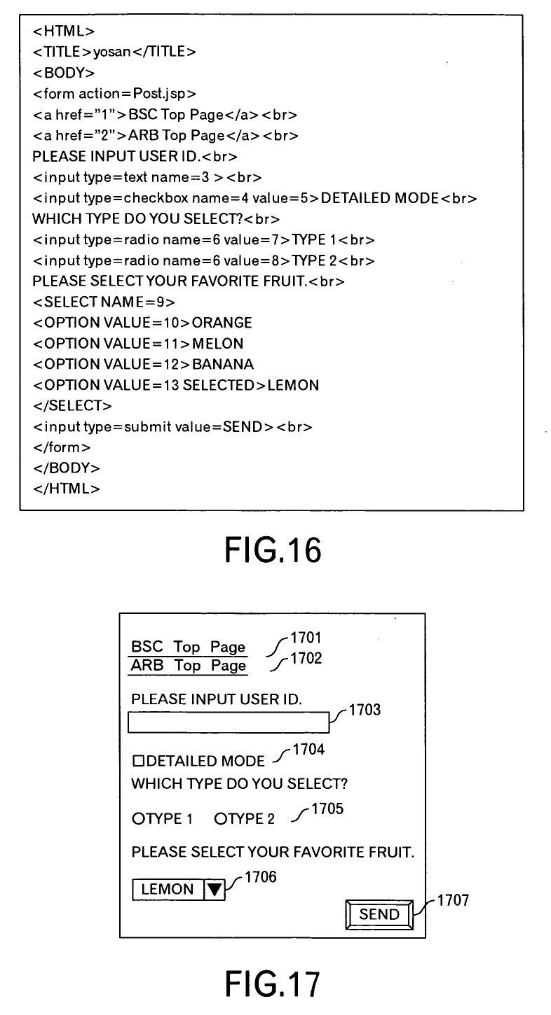

When the conversion processing as stated above is performed, a conversion table as shown in FIG. 15 is stored in the conversion table storage 37. That is, a code after the conversion is made to correspond to a character string before the conversion. This conversion table is provided for each user and each session. That is, it is intrinsic to the user, and even if the user is the same, the conversion table is not basically used in common in two or more HTML files. The codes are numerals of “1” to “13”. However, they may be an alphabet of “a” to “m”, or random numerals, not in order of detection, may be given. The HTML file generated in accordance with the conversion table and stored in the third Web page data storage 36 is as shown in FIG. 16. That is, the <a href=“http://www.bsc.co.jp/bsc/”> tag is converted into an <a href =“1”> tag; the <a href=“http://www.bsc.co.jp/arb/”>, an <a herf=“2”> tag; the <input type=text name=uid> tag, an <input type=text name=3> tag; the <input type=checkbox name=mode value=“on”> tag, an <input type=checkbox name=4 value=5> tag; the <input type=radio name=course value=“type 1”> tag, an <input type=radio name=6 value=7> tag; the <input type=radio name=course value=“type 2”> tag, an <input type=radio name=6 value=8> tag; the <select name=“FRUIT”> tag, a <select name=9> tag; the <OPTION VALUE=“ORANGE”> tag, an <OPTION VALUE=10> tag; the <OPTION VALUE=“MELON”> tag, an <OPTION VALUE=11> tag; the <OPTION VALUE=“BANANA”> tag, an <OPTION VALUE=12> tag; and the <OPTION VALUE=“LEMON” SELECTED> tag, an <OPTION VALUE=13 SELECTED> tag.

As a result, not only the duplicate tag for prescribing the display mode of the character, but also the attribute value of the tag having a possibility that it is sent back from the user terminal later is converted into the code, and therefore, the communication data amount can be reduced without influencing the display contents at the user terminal. Because there is a possibility that the tag is sent back from the user terminal, the communication data amount can be reduced not only in the down stream to the user terminal, but also in the up stream from the user terminal to the Web contents control system 3. Besides, the original contents cannot be presumed from the numerals of “1” to “13”, and the security level is also raised.

Incidentally, with respect to both the HTML file as shown in FIG. 14 and the HTML file as shown in FIG. 16, a screen as shown in FIG. 17 is displayed on the display device of the user terminal. The example of FIG. 17 includes a “BSC Top Page” link 1701, an “ARB Top Page” link 1702, a user ID input column 1703, a check box 1704 of a detailed mode, a radio button 1705 for selecting either one of type 1 and type 2, a combo box 1706 and a transmission button 1707.

Returning to the description of the processing flow of FIG. 4, the transmitter 38 of the Web contents control system 3 transmits the HTML file (Web page data) after modification stored in the third Web page data storage 36 to the user terminal (step S11). The user terminal receives the Web page data after the modification from the Web contents control system 3 and displays it on the display device (step S13). As stated above, it is assumed that for example, the screen as shown in FIG. 17 is displayed.

It is assumed that the user operates the user terminal, an input of “8003” into the user ID input column 1703, checks the check box 1704 of the detailed mode, selects “type 1” in the radio button 1705, selects “lemon” in the combo box 1706, and clicks the send button 1707. Then, the Web browser of the user terminal receives the user input, generates a request message of “http://(Host portion in ULR of the Web contents control system 3)/Post.jsp?3=8003 & 4=5 & 6=7 & 9=13”, and transmits it to the Web contents control system 3 (step S15). The host portion in the URL of the Web contents control system 3 is specified from the URL of the displayed HTML file. This is because Post.jsp is specified by a relative path. The proxy access unit 31 of the Web contents control system 3 receives the request message from the user terminal (step S17), and converts the request message in accordance with the conversion table of the conversion table storage 37 (step S19). In the case of the above request message, a request message of “http://(Host portion in URL of the corresponding Web site)/Post.jsp?uid=8003&mode=“on” & course=type 1 & FRUIT=lemon (“lemon” is specified using a URL escape code)” is transmitted to, for example, the Web server 9 (step S21). The transmission processing is not different from a normal processing, a further description will not be made. Then, the processing returns to the step S5. When returning to the step S5, the conversion table used at the step S19 is basically cleared.

At the step S15, in the case where the user clicks the “BSC TOP Page” link 1701, the user terminal generates a request message of “http://(Host portion in URL of the Web contents control system 3)/1”, and transmits it to the Web contents control system 3. The proxy access unit 31 of the Web contents control system 3 converts the request message into a request message of “http://www.bsc.co.jp/bsc/” in accordance with the conversion table, and transfers it to, for example, the Web server 9.

By performing the processing as stated above, the communication data amount can be reduced, and further, in the case where the code conversion is performed, the security level can be raised.

In the above description, although the example in which the session ID is basically exchanged by the cookie, there is also another method. For example, after the processing of FIG. 8 is performed, the attribute of specifying a jump destination URL is extracted, and data of a session ID is added. An attribute such as, for example, an action attribute of a <form> tag or a href attribute of a <A> tag, is extracted, and for example, “?jsessionid=XXXX” (XXXX is the session ID itself) is added to the attribute value. For example, in the example of FIG. 16, the conversion is made to form “<form action=Post.jsp?jsessionid=XXXX>”, “<A href=“1?jsessionid=XXXX”>” and “<A herf=“2?jsession=XXXX”>”.

As a result, the request message from the user terminal becomes “http://(host portion in URL of the Web contents control system 3)/Post.jsp?jsessionid=XXXX?3=8003 & 4=5 & 6=7 & 9 =13”, and the session ID can be specified from only the request message. Also with respect to another example, the request message becomes “http://(host portion in URL of the Web contents control system 3)/1?jsessionid=XXXX”, and the session ID can be specified similarly.

### 2. Second Embodiment

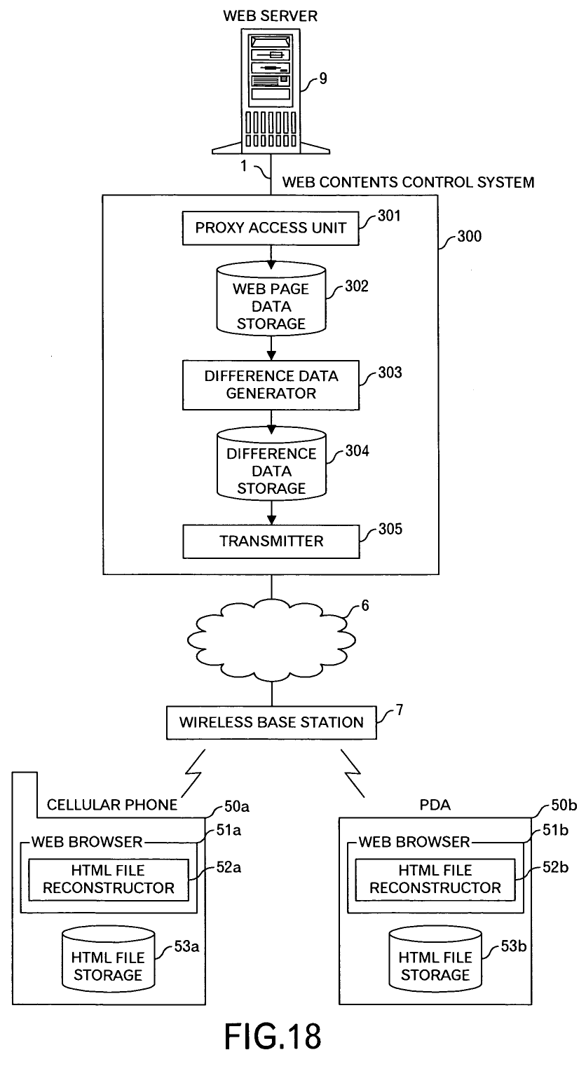

Next, a second embodiment of the invention will be described. FIG. 18 is a system outline diagram of this embodiment. Incidentally, the same elements as those of FIG. 1 are denoted by the same reference numerals. A network 1 is connected with one or plural Web servers 9 and a Web contents control system 300 for performing a main processing of this embodiment. The Web contents control system 300 is connected with a wireless base station 7 through a network 6. A cellular phone 50a and/or a PDA 50b of this embodiment is connected to the wireless base station 7 by wireless. Also here, the number of cellular phones 50a, PDAs 50b, or wireless base stations 7 may be arbitrary.

The Web contents control system 300 in this embodiment includes a proxy access unit 301, which accesses the Web server 9 on behalf of the cellular phone 50a or the like, receives Web page data (HTML file) and stores it into a Web page data storage 302, the Web page data storage 302 for storing the Web page data acquired by the proxy access unit 301, a difference data generator 303 for extracting a difference between previous Web page data stored in the Web page data storage 302 for a specific user terminal and Web page data received this time for the specific user terminal, generating difference data and storing it into a difference data storage 304, the difference data storage 304 for storing the difference data generated by the difference data generator 303, and a transmitter 305 for transmitting the difference data stored in the difference data storage 304 to the cellular phone 50a or the like.

The cellular phone 50a in this embodiment includes a Web browser 51a of this embodiment, and an HTML file storage 53a for storing an HTML file used just before. The Web browser 51a includes an HTML file reconstructor 52a for reconstructing an HTML file to be used this time from the difference data from the Web contents control system 300 and the HTML file used just before and stored in the HTML file storage 53a. The PDA 50b also has the same configuration.

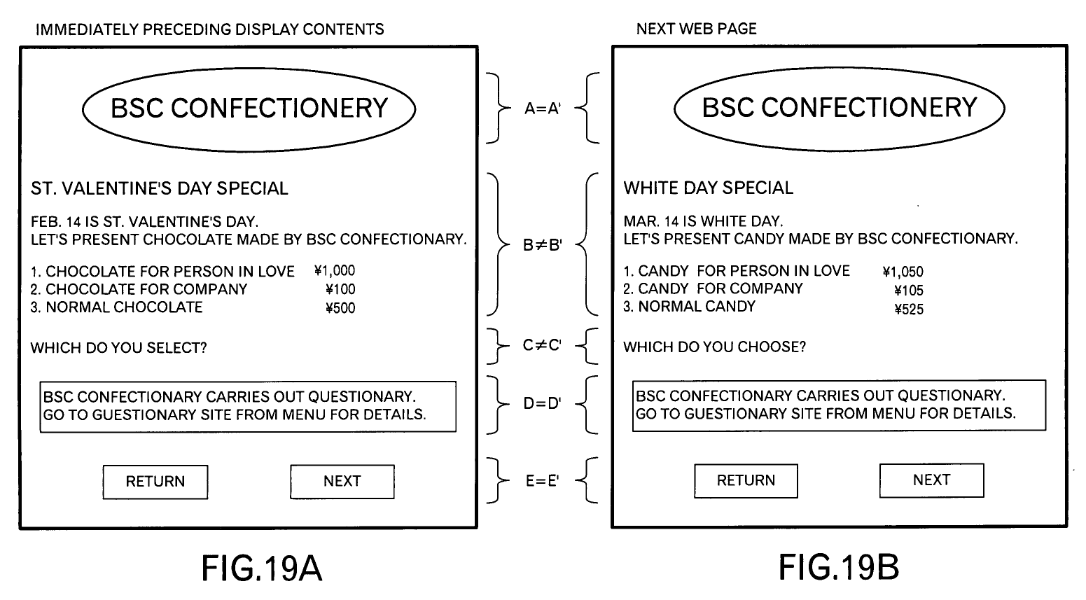

In this embodiment, only the difference data relating to the difference between the previous display and the current display (and editing data described below) is transmitted from the Web contents control system 300 to the cellular phone 50a or the like, so that the communication data amount is reduced. For example, in the case where the immediately preceding display contents are as shown in FIG. 19A and access is next made to a Web page including display contents as shown in FIG. 19B, a display portion A of FIG. 19A is the same as a display portion A′ of FIG. 19B, a display portion B of FIG. 19A is different from a display portion B′ of FIG. 19B, a display portion C of FIG. 19A is different from a display portion C′ of FIG. 19B, a display portion D of FIG. 19A is the same as a display portion D′ of FIG. 19B, and a display portion E of FIG. 19A is the same as a display portion E′ of FIG. 19B. Accordingly, only data for the display portion B′ and the display portion C′ and editing data necessary for the HTML file reconstructor 52a of the Web browser 51a are transmitted from the Web contents control system 300 to the cellular phone 50a.

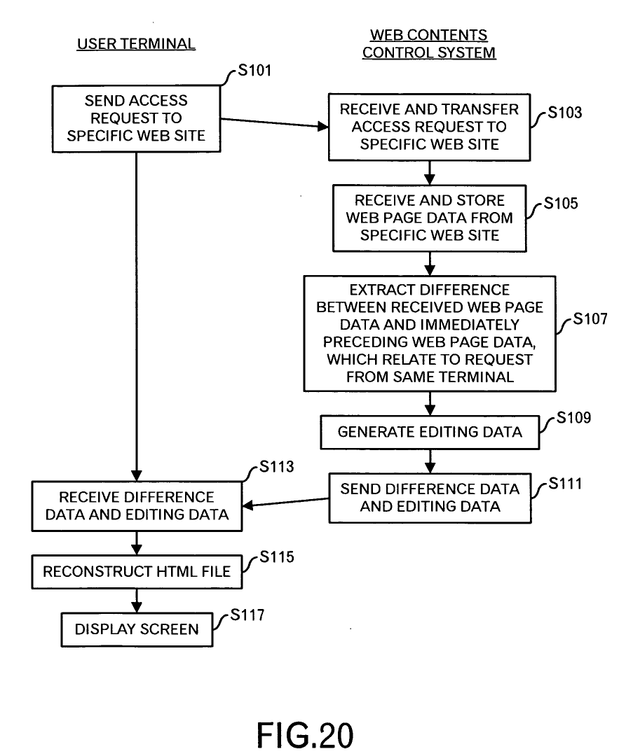

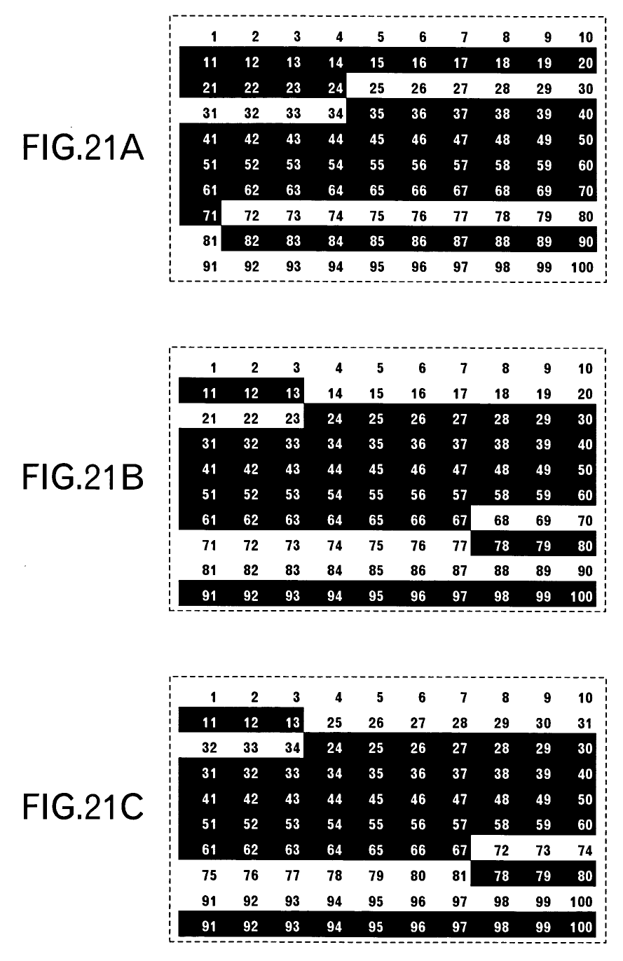

Hereinafter, a processing flow of the system shown in FIG. 18 will be described with reference to FIGS. 20 and 21. Incidentally, in the case where authentication for using the Web contents control system 300 is required, it is assumed that the authentication has already been made. First, the user operates the user terminal (the cellar phone 50a or the PDA 50b) and causes an access request to be transmitted to a specific Web site (Web server) (step S101). A cookie or the like to specify a session is also transmitted. When receiving the access request from the user terminal, the proxy access unit 301 of the Web contents control system 300 transfers the access request to the specific Web site (step S103). It is assumed that the correspondence between the received URL (Uniform Resource Locator) and the URL of the transmission destination Web server is previously registered in the Web contents control system 300.

The proxy access unit 301 receives Web page data from the specific Web site and stores it in the Web page data storage 302 (step S105). The Web page data is stored in the Web page data storage 302 so as to correspond to, for example, a session ID or a user ID. In the Web page data storage 302, (1) the immediately preceding HTML file and (2) the HTML file received this time are stored correspondingly to the session IDs and the like. In this embodiment, only an HTML file is treated, and other files are transferred to the user terminal as they are.

Then, the difference data generator 303 refers to the Web page data storage 302, compares the Web page data received this time with the immediately preceding Web page data, and relate to the request from the same user terminal, and extracts the difference (step S107).

For example, FIG. 21A schematically shows character strings of the immediately preceding HTML file, and FIG. 21B schematically shows character strings of the HTML file received this time. Each numeral in FIG. 21A and FIG. 21B indicates a character position, and it is assumed that a character is arranged at a position of each numeral. Besides, in FIG. 21A, outline characters on a colored background indicate a character string different from FIG. 21B, and a portion where normal numerals are shown indicates a character string common to FIG. 21B. In FIG. 21B, outline characters on a colored background indicates a character string different from FIG. 21A, and a portion where normal numerals are shown indicates a character string common to FIG. 21A. In this example, the previous characters 1 to 10 are coincident with the current characters 1 to 10; the previous characters 25 to 34, the current characters 14 to 23; the previous characters 72 to 81, the current characters 68 to 77; and the previous characters 91 to 100, the current characters 81 to 90. Accordingly, as characters to be transmitted, the current characters 11 to 13, the characters 24 to 67, the characters 78 to 80, and the characters 91 to 100 are specified as the difference data, and are stored in the difference data storage 304.

The difference data generator 303 generates the editing data, and stores it in the difference data storage 304 (step S109). The editing data is the data indicating how to reconstruct the HTML file. In the example shown in FIG. 21A and FIG. 21B, the data is such that the previous characters 1 to 10 are arranged from position 1; the characters 25 to 34, position 14; the characters 72 to 81, position 68; and the characters 91 to 100, position 81. That is, the data indicates that the previous character string should be copied to which position. The difference data has only to be arranged so as to fill in character positions not specified by the editing data in order of transmission (in order of reception when viewed from the Web browser 51a). That is, it is understood that a character transmitted first (original character position 11) to a character transmitted third (original character position 13) are arranged at positions 11 to 13, a character transmitted fourth (original character position 24) to a character transmitted 47th (original character position 67) are arranged at positions 24 to 67, a character transmitted 48th (original character position 78) to a character transmitted 50th (original character position 80) are arranged at positions 78 to 80, and a character transmitted 51th (original character position 91) to a character transmitted 60th (original character position 100) are arranged at positions 91 to 100.

The transmitter 305 transmits the difference data and the editing data to the user terminal (step S111). The Web browser 51a of the user terminal receives the difference data and the editing data from the Web contents control system 300, and stores it in a storage device such as a main memory (step S113). The HTML file reconstructor 52a of the Web browser 51a refers to the previous HTML file stored in the HTML file storage 53a, reconstructs the current HTML file in accordance with the editing data and the difference data, and stores it in the HTML file storage 53a (step S115). As described above, the data of the previous HTML file is arranged in accordance with the editing data, and the remaining portion is filled in turn with the difference data received this time, so that the current HTML file is reconstructed. For example, the HTML file as shown in FIG. 21C is reconstructed. Because the current HTML file is used for reconstructing a next HTML file, it is stored in the HTML file storage 53a.

The Web browser 51a performs a screen display in accordance with the reconstructed HTML file (step S117). In the case where an image file or the like is required, a request is separately issued to acquire it, and a display is carried out. Thereafter, the processing returns to the step S101, and the processing flow of FIG. 20 is repeated.

By performing the processing as described above, the communication data amount can be made small as compared with the case where an HTML file which is hardly different from the immediately preceding file is again transmitted.

In the case of a quite different HTML file, the HTML file becomes the difference data, and there is no editing data to specify a utilizing method of the previous HTML file.

Although the embodiments of the invention have been described, the invention is not limited to these, and various modifications can be made. For example, the first embodiment and the second embodiment can be combined with each other. In that case, for example, after the processing of the first embodiment is performed, the processing of the second embodiment is performed. In that case, because the code conversion is performed each time, there is a case where portions judged to be coincident become small. Thus, when the conversion table is maintained for a long period for the same user, it is estimated that portions judged to be coincident become large.

Besides, the functional block diagrams shown in FIGS. 1 and 18 are examples, and do not necessarily coincide with an actual program module configuration.

Further, in the foregoing processing flow, there are also portions whose processing order can be exchanged.

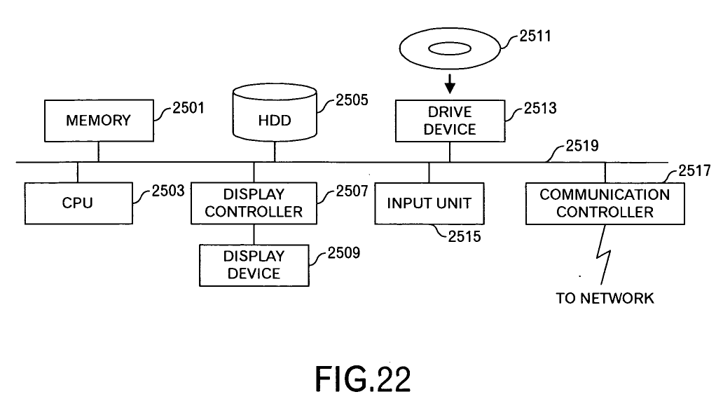

The Web contents control systems 3 and 300 are computers, and the computer has a configuration as shown in FIG. 22. That is, a memory 2501, a CPU 2503, a hard disk drive (HDD) 2505, a display controller 2507 connected to a display device 2509, a drive device 2513 for a removal disk 2511, an input device 2515, and a communication controller 2517 for connection with a network are connected through a bus 2519. An operating system (OS) and an application program for carrying out the foregoing processing in respective embodiments, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operation. Besides, intermediate processing data is stored in the memory 2501, and if necessary, it is stored in the HDD 2505. In this embodiment of this invention, the application program to realize the aforementioned functions is stored in the removal disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application program are systematically cooperated with each other, so that various functions as described above in details are realized.

In addition, with respect to the cellular phone 5a and/or PDA 5b, a flash memory is held instead of the HDD 2505 and the drive device 2513, and there is no large difference.

Although the present invention has been described with respect to a specific preferred embodiment thereof, various change and modifications may be suggested to one skilled in the art, and it is intended that the present invention encompass such changes and modifications as fall within the scope of the appended claims.

1. An HTML file processing method, comprising:
specifying a character string not affecting a display at a user terminal in an HTML file received from another server according to a request from said user terminal by referring to a definition data storage storing data for specifying said character string not affecting said display at said user terminal; and
changing said HTML file so as to reduce data amount in accordance with a method corresponding to an attribute of the specified character string, and transmitting the changed HTML file to said user terminal.

2. The HTML file processing method as set forth in claim 1, wherein said changing and transmitting comprises:
if the specified character string is a character string having a possibility that it is sent back from said user terminal, assigning a code to the specified character string, and constructing a correspondence table between said character string and said code; and
changing said HTML file in accordance with said correspondence table, and transmitting the changed HTML file to said user terminal.

3. The HTML file processing method as set forth in claim 1, wherein said changing and transmitting comprises:
if the specified character string is a duplicate tag for specifying a display mode of a character, generating an HTML file without the specified character string.

4. The HTML file processing method as set forth in claim 2, wherein said code is a character string shorter than said specified character string.

5. The HTML file processing method as set forth in claim 2, wherein said code is a character string arbitrarily assigned without duplication with the specified character string in said HTML file

6. The HTML file processing method as set forth in claim 2, further comprising:
if a message including said code is received from said user terminal, referring to said correspondence table, and replacing said code in said message with the corresponding character string; and
transferring said message after the replacement.

7. The HTML file processing method as set forth in claim 3, wherein said definition data storage stores tag names to be specified, and
said specifying comprises:
judging whether or not a tag having a tag name stored in said definition data storage is included in said HTML file, and said tag or a combination of said tag and an attribute value associated with said tag successively appears a plurality of times; and
if it is judged that said tag or said combination of said tag and said attribute value associated with said tag successively appears a plurality of times, specifying said tags and end tags of said tags other than a first tag of said tags and a last end tag of said end tags as said character strings.

8. The HTML file processing method as set forth in claim 2, wherein said definition data storage stores a tag name not affecting said display at said user terminal and an attribute name in said tag, and
said specifying comprises:
judging whether in the HTML file, an attribute having said attribute name stored in said definition data storage is prescribed in a tag having said tag name stored in said definition data storage; and
if it is judged at said judging that said attribute having said attribute name stored in said definition data storage is prescribed in said tag having said tag name stored in said definition data storage, specifying said attribute value as said character string.

9. An HTML file processing program embodied on a medium, said program comprising:
specifying a character string not affecting a display at a user terminal in an HTML file received from another server according to a request from said user terminal by referring to a definition data storage storing data for specifying said character string not affecting said display at said user terminal; and
changing said HTML file so as to reduce data amount in accordance with a method corresponding to an attribute of the specified character string, and transmitting the changed HTML file to said user terminal.

10. The HTML file processing program as set forth in claim 9, wherein said changing and transmitting comprises:
if the specified character string is a character string having a possibility that it is sent back from said user terminal, assigning a code to the specified character string, and constructing a correspondence table between said character string and said code; and
changing said HTML file in accordance with said correspondence table, and transmitting the changed HTML file to said user terminal.

11. The HTML file processing program as set forth in claim 9, wherein said changing and transmitting comprises:
if the specified character string is a duplicate tag for specifying a display mode of a character, generating an HTML file without the specified character string.

12. The HTML file processing program as set forth in claim 10, wherein said code is a character string shorter than said specified character string.

13. The HTML file processing program as set forth in claim 10, wherein said code is a character string arbitrarily assigned without duplication with the specified character string in said HTML file

14. The HTML file processing program as set forth in claim 10, further comprising:
if a message including said code is received from said user terminal, referring to said correspondence table, and replacing said code in said message with the corresponding character string; and
transferring said message after the replacement.

15. The HTML file processing program as set forth in claim 11, wherein said definition data storage stores tag names to be specified, and
said specifying comprises:
judging whether or not a tag having a tag name stored in said definition data storage is included in said HTML file, and said tag or a combination of said tag and an attribute value associated with said tag successively appears a plurality of times; and
if it is judged that said tag or said combination of said tag and said attribute value associated with said tag successively appears a plurality of times, specifying said tags and end tags of said tags other than a first tag of said tags and a last end tag of said end tags as said character strings.

16. The HTML file processing program as set forth in claim 10, wherein said definition data storage stores a tag name not affecting said display at said user terminal and an attribute name in said tag, and
said specifying comprises:
judging whether in the HTML file, an attribute having said attribute name stored in said definition data storage is prescribed in a tag having said tag name stored in said definition data storage; and
if it is judged at said judging that said attribute having said attribute name stored in said definition data storage is prescribed in said tag having said tag name stored in said definition data storage, specifying said attribute value as said character string.

17. An HTML file processing apparatus, comprising:
a specifying unit that specifies a character string not affecting a display at a user terminal in an HTML file received from another server according to a request from said user terminal by referring to a definition data storage storing data for specifying said character string not affecting said display at said user terminal; and
a changing and transmitting unit that changes said HTML file so as to reduce data amount in accordance with a method corresponding to an attribute of the specified character string, and transmits the changed HTML file to said user terminal.

18. The HTML file processing apparatus as set forth in claim 16, wherein said changing and transmitting unit
a unit that assigns a code to the specified character string, if the specified character string is a character string having a possibility that it is sent back from said user terminal, and constructs a correspondence table between said character string and said code; and
a unit that changes said HTML file in accordance with said correspondence table, and transmits the changed HTML file to said user terminal.

19. The HTML file processing apparatus as set forth in claim 16, wherein said changing and transmitting unit comprises:
a generator that generates an HTML file without the specified character string, if the specified character string is a duplicate tag for specifying a display mode of a character.

20. The HTML file processing apparatus as set forth in claim 17, wherein said code is a character string shorter than said specified character string.

21. The HTML file processing apparatus as set forth in claim 17, wherein said code is a character string arbitrarily assigned without duplication with the specified character string in said HTML file

22. The HTML file processing apparatus as set forth in claim 17, further comprising:
a unit that refers to said correspondence table, if a message including said code is received from said user terminal, and replaces said code in said message with the corresponding character string; and
a unit that transfers said message after the replacement.

23. The HTML file processing apparatus as set forth in claim 18, wherein said definition data storage stores tag names to be specified, and
said specifying unit comprises:
a unit that judges whether or not a tag having a tag name stored in said definition data storage is included in said HTML file, and said tag or a combination of said tag and an attribute value associated with said tag successively appears a plurality of times; and
a unit that specifies said tags and end tags of said tags other than a first tag of said tags and a last end tag of said end tags as said character strings, if it is judged that said tag or said combination of said tag and said attribute value associated with said tag successively appears a plurality of times.

24. The HTML file processing apparatus as set forth in claim 17, wherein said definition data storage stores a tag name not affecting said display at said user terminal and an attribute name in said tag, and
said specifying unit comprises:
a unit that judges whether in the HTML file, an attribute having said attribute name stored in said definition data storage is prescribed in a tag having said tag name stored in said definition data storage; and
a unit that specifies said attribute value as said character string, if it is judged at said judging that said attribute having said attribute name stored in said definition data storage is prescribed in said tag having said tag name stored in said definition data storage.
